(19) United States
(12) Patent Application Publication
(10) Pub. No.: US 2014/0061482 A1
(43) Pub. Date: Mar. 6, 2014

(54) ENHANCED RESPONSE OF SOLID STATE PHOTOMULTIPLIER TO SCINTILLATOR LIGHT BY USE OF WAVELENGTH SHIFTERS

(71) Applicants: James A. Wear, Madison, WI (US); Sergei Dolinsky, Clifton Park, NY (US); Ravindra Mohan Manjeshwar, Glenville, NY (US)

(72) Inventors: James A. Wear, Madison, WI (US); Sergei Dolinsky, Clifton Park, NY (US); Ravindra Mohan Manjeshwar, Glenville, NY (US)

(73) Assignee: GENERAL ELECTRIC COMPANY, Schenectady, NY (US)

(21) Appl. No.: 13/605,082

(22) Filed: Sep. 6, 2012

(51) Int. Cl. G01T 1/20

(52) U.S. Cl. 250/362; 250/368

(57) ABSTRACT

A wavelength shifting material is optically coupled to one of a scintillator and a solid-state photomultiplier and transmits photons along and about a straight linear path. The wavelength shifting material enhances photon sensing performance of the solid state photomultiplier.

### CROSS-REFERENCE TO RELATED PATENT APPLICATIONS

The present application is related to co-pending U.S. patent application Ser. No. ______ file on the same date here with by James A. Wear, Sergei I. Dolinsky, Randall K. Payne and Ravindra Mohan Manjeshwar and entitled RADIATION ABSORPTIOMETRY SOLID-STATE PHOTOMULTIPLIER, the full disclosure of which is hereby incorporated by reference.

### BACKGROUND

Some medical imaging systems detect radiation that has passed through a body being imaged. In some medical imaging systems, a scintillator receives the radiation and produces photons which are detected by a solid-state photomultiplier or photo diode. Many medical imaging systems employing a scintillator and solid-state photomultiplier exhibit low photon detection efficiency.

### BRIEF DESCRIPTION OF THE INVENTION

An example apparatus comprises one of a scintillator and a solid-state photomultiplier, wherein a wavelength shifting material is optically coupled to said one of the scintillator and the solid-state photomultiplier, wherein the wavelength shifting material transmits photons from an input side of the material to an output side of the material along a straight linear path.

An example medical imaging system comprises a radiation source, a scintillator, a wavelength shifting material and a solid-state photomultiplier. The scintillator receives rays of radiation emitted by the radiation source that have passed through an imaged body. The wavelength shifting material is optically coupled to the scintillator to shift a wavelength of an optical photon received from the scintillator, wherein the wavelength shifting material transmits photons from an input side of the material to an output side of the material along a straight linear path. The solid-state photomultiplier is optically coupled to the wavelength shifting material to receive the optical photon having the wavelength shifted by the wavelength shifting material.

According to an example method, ionizing radiation that has passed through a body being imaged is received. Absorbed energy is converted into photons having a first wavelength. The photons are absorbed by the wavelength shifting material, are emitted from the wavelength shifting material with a second wavelength shifted from the first wavelength and are transmitted in a linear straight path to an output side of the wavelength shifting material. The photons with a second wavelength are received and sensed by a solid-state photomultiplier to produce an electrical signal.

### BRIEF DESCRIPTION OF THE DRAWINGS

FIG. 1 is a schematic illustration of an example radiation detector.

FIG. 2 is a schematic illustration of an example imaging system including the radiation detector of FIG. 1.

FIG. 3 is a flow diagram of an example method that may be carried out by the radiation detector of FIG. 1.

FIG. 4 is a schematic illustration of an example implementation of the radiation detector FIG. 1.

FIG. 5 is a schematic illustration of a radiation detector component for forming the radiation detector of FIG. 4.

FIG. 6 is a schematic illustration of a radiation detector component for forming the radiation detector of FIG. 4.

FIG. 7 is a schematic illustration of an example implementation of the radiation detector of FIG. 1.

FIG. 8 is a schematic illustration of an example imaging system including the radiation detector of FIG. 1.

### DETAILED DESCRIPTION OF THE EXAMPLE EMBODIMENTS

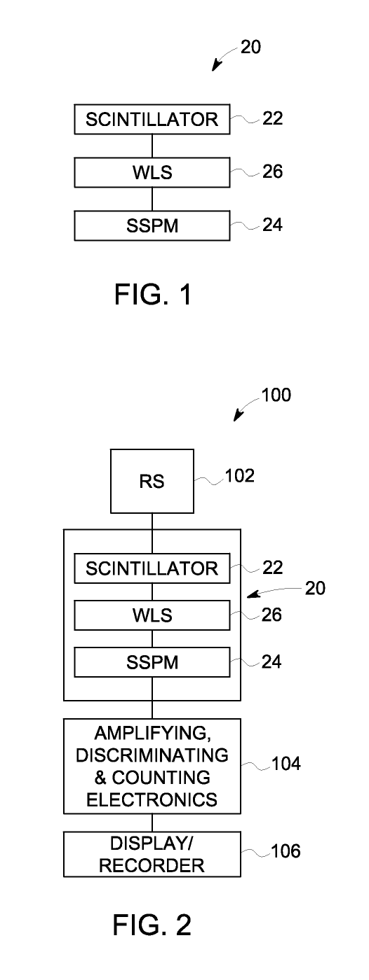

FIG. 1 schematically illustrates an example radiation detector 20. Radiation detector 20 comprise a solid-state photomultiplier detector. Radiation detector 20 may be employed in various applications such as imaging systems and the like. Radiation detector 20 converts received radiation into photons or light which is sensed to produce an electrical signal. As will be described hereafter, radiation detector 20 achieves enhanced (or higher) photon detection efficiency by shifting the wavelength of the photons prior to their detection.

Radiation detector 20 comprises scintillator 22, solid-state photomultiplier 24 and wavelength shifting material 26. Scintillator 22 comprises a material that exhibits scintillation, the property of luminescence when excited by ionizing radiation. In response to receiving or being impinged by ionizing radiation, such as x-rays or gamma rays, scintillator 22 converts the received ionizing radiation (the incident rays of radiation) into photons or light which is subsequently emitted from scintillator 22. Scintillator 22 directs the emitted photons or light towards solid-state photomultiplier 24 through wavelength shifting material 26. In one implementation, scintillator 22 includes one or more reflective surfaces on its outer periphery that direct or guide the produced photons through a defined opening towards the solid-state photomultiplier 24.

In one example implementation, scintillator 22 comprises a crystal of one or more scintillation materials that are relatively fast, dense and bright. Examples of such scintillation materials include, but are not limited to, Lu1.8Y0.2SiO5:Ce (LYSO); Lu2SiO5:Ce (LSO); NaLTl; Gd2SiO5:Ce (GSO); LaBr3:Ce; YAP; LuAlO2 (LuAP); and BaF2. When formed from such scintillation materials, scintillator 22 converts incident x-rays into optical photons having a peak wavelength of 310-420 nm (blue light). The blue light is reflected out of scintillator 22 towards solid-state photomultiplier 24 and wavelength shifting material 26.

Solid-state photomultiplier 24 comprises a device configured to sense photons and to produce an electrical signal in response to such photons. In particular, solid-state photomultiplier 24 absorbs the photons or light emitted by scintillator 22 and further shifted by wavelength shifter material 26, wherein solid-state photomultiplier 24 re-emits the light in the form of electrons via the photoelectric effect. The multiplication of electrons (photo-electrons) by solid-state photomultiplier 24 produces an electrical pulse which may be subsequently analyzed for information about the particle or radiation that originally struck scintillator 22 As will be described hereafter, in one example implementation, such electrical signals output by photomultiplier 24 are counted or otherwise analyzed to produce an image. Examples of solid-state photomultiplier 24 include, but are not limited to, a silicon photomultiplier diode, or a Geiger-mode multi-pixel avalanche photodiode.

Solid-state photomultiplier 24 converts photons to electrons at a quantum efficiency characteristic. Solid-state photomultiplier 24 has a maximum quantum efficiency when receiving photons having an optimal wavelength. In one implementation, the optimal wavelength of a photon at which solid-state photomultiplier 24 converts the photon to an electron or electrical signal is a wavelength between 450 nm and 600 nm. In one implementation, the quantum efficiency of solid-state photomultiplier 24 exhibits a bell curve with the peak of the bell curve occurring at the optimal wavelength of 500 nm (green light) or thereabouts. In one implementation, solid-state photomultiplier 24 has a photon detection efficiency of between 4% and 5% when receiving photons having a peak wavelength of around 420 nm and a photon detection efficiency of about 14% when receiving photons having a peak wavelength of about 500 nm.

Wavelength shifting material 26 comprises one or more structures or one or more materials optically coupled between and to each of scintillator 22 and solid-state photomultiplier 24 that shift the wavelength of received photons. For purposes of this disclosure, the term or phrase “optically coupled” shall mean that the two components that are “optically coupled” are arranged such that photons emitted by one component are guided or directed to the other component, either through direct contact between the components or through one or more intermediate mediums such as through an empty space, a liquid filled space or a gas filled space, an optical transmission structure such as a lens or light guide, or a compound, whether be solid, semisolid or fluid. Such optical coupling may result in the direct transmission of photons or the reflected transmission of photons using one or more reflective surfaces.

Wavelength shifting material 26 shifts the wavelength of the photons received from scintillator 22 to a different wavelength at which solid-state photomultiplier 24 has an enhanced photon detection efficiency. In one example implementation, wavelength shifting material 26 upwardly shifts the wavelength of the photons received from scintillator 22. In one implementation, wavelength shifting material 26 receives photons having a peak wavelength of less than 450 nm (nominally 420 nm; the blue light being emitted by scintillator 22) and isotropically re-emits the same photons with the wavelength of at least 450 nm and less than or equal to about 600 nm (nominally 500 nm within a range of green light (480 nm to 600 nm).

The shifted photons emitted from wavelength shifting material 26 are directed or guided to solid-state photomultiplier 24. In the example illustrated, the wavelength shifting material transmits photons from an input side of the material to an output side of the material along and about a straight linear path. For purposes of this disclosure, any phrases referring to the transmission of photons by the wavelength shifting material from an input side to an output side along and about a straight linear path means that wavelength shifted light is directed along a path largely normal to the primary light emission face of the scintillator. In one implementation, the input side and the output side are oriented such that a single linear (straight) axis may intersect the input side and the output side without exiting the body of the wavelength shifting material between such sides. During the transmission of photons within the wavelength shifting material, such photons may travel along nonlinear paths or paths consisting of multiple non-parallel linear segments; however, the wavelength shifted light is still directed along or about a path largely normal to the primary light emission face of the scintillator. Although the wavelength of photons are sometimes shifted for the sole purpose of facilitating steering of the photons through bends and turns of a wavelength shifting material, such as through a bent or turning light pipe, in such applications, because the wavelength shifting material itself bent or is intended to turn, photons are not transmitted by the wavelength shifting material from an input side to an output side along a straight linear path as defined in the present disclosure.

Because the wavelength shifting material shifts the wavelength of photons while such photons are transmitted from an input side to an output side along and about a straight linear path, the photons may be more efficiently transmitted and detector 20 may be more compact. In one implementation, wavelength shifting material 26 comprises a wavelength shifting light guide. In another implementation, wavelength shifting material 26 may comprise a wavelength shifting compound.

FIG. 2 schematically illustrates an example imaging system 100 including radiation detector 20. In addition to radiation detector 20, imaging system 100 comprises radiation source 102, amplifying, discriminating and counting electronics 104 and display/recorder 106. Radiation source 102 comprises a source of ionizing radiation which directs such ionizing radiation through, across and around a body being imaged by system 100 for purposes of this disclosure, the term “body” shall mean any animate or inanimate structure being imaged by system 100, including both living and nonliving structures or organisms. In one implementation, radiation source 102 comprises a source of x-rays. In other implementations, radiation source 102 may comprise a source of other rays which may excite scintillator 22 of detector 20, such as gamma rays.

In one implementation, imaging system 100 comprises a dual energy x-ray absorptiometry device (DEXA or DXA system) in which radiation source 102 supplies or directs two distinct levels of radiation towards a body being imaged for the purpose of determining such information such as bone mineral density for osteoporosis or lean versus adipose tissue composition of a body region. In one example, radiation source 102 admits to levels of x-rays: (1) one level at 20 KeV and (2) a second level at 76 KeV. The signals received from solid-state photomultiplier 24 of detector 20 are categorized into two corresponding bins: (1) a first bin comprising those signals between 20 and 50 KeV (originating from the 20 KeV level) and (2) a second bin comprising those signals between 50 and 76 KeV (originating from the 76 KeV level). The difference in the number of signals in each of the bins is then used, using various formulations and mathematics, to quantify how much bone mineral is in the path of the x-ray (bone mineral density). Additional details regarding such exemplary bone density detection may be found in co-pending U.S. patent application Ser. No. 12/557,314 filed on Sep. 10, 2009 by Wear et al (published as US Patent Publication 2011/0058649), the full disclosure of which is hereby incorporated by reference. In other implementations, other energy levels or a different number of energy levels may be supplied by radiation source 102. In other implementations, imaging system 100 may be used for other purposes and may include other configurations for radiation source 102 and electronics 104.

Electronics 104 comprise electronics that receive the microcell electrical pulses or electrical signals from solid-state photomultiplier 24 of detector 20. In the example illustrated, electronics 104 amplifies such signals, discriminates such signals and counts such signals. In one implementation, electronics 104 includes a buffer amplifier to amplify the electrical signals. In one implementation, electronics 104 further includes discriminators that compare a voltage of a signal to a predefined threshold voltage to determine whether the signal being received is the result of the reception of a photon by solid-state photomultiplier 24 or is due to noise. Those signals that are determined to have a voltage greater than a threshold voltage are counted by electronics 104.

Display/recorder 106 receives the counted values for such signals and utilizes such values to generate or produce an image. In one implementation, display/recorder 106 includes a monitor or display screen on which the image is visually displayed for viewing. In one implementation, display/recorder 106 includes a recordation device to record the produce images. Examples of such a recordation device include a printer or a persistent storage device such as a flash memory, optical disk, magnetic disk or tape or other memory device. In one implementation, display/recorder 106 may include both a display and a recordation device. In one implementation, electronics 104 and display/recorder 106 may be part of a self-contained unit. In yet other implementations, display/recorder 106 may be remote, receiving signals from electronics 104 in a wired or wireless fashion across a network.

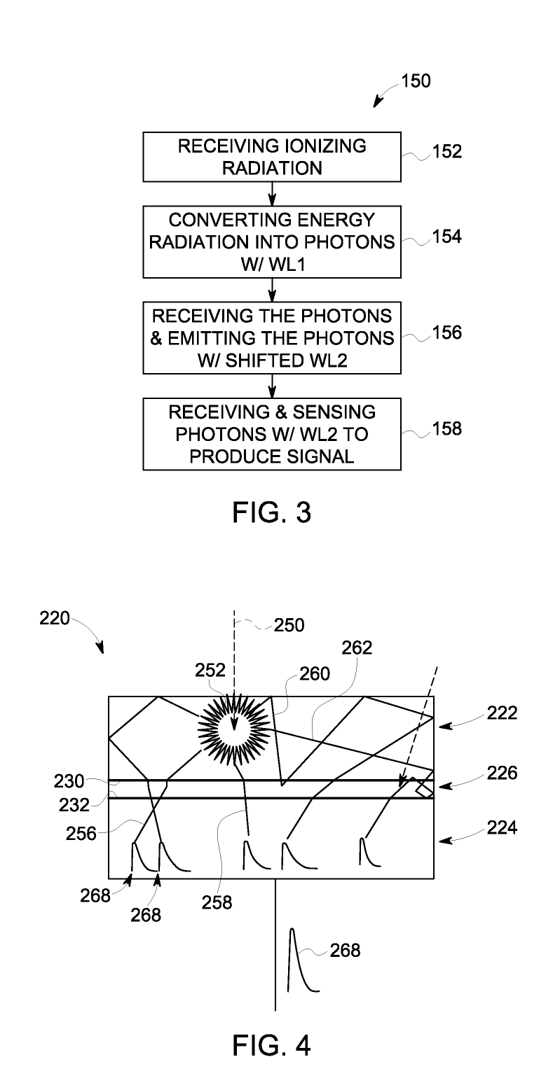

FIG. 3 is a flow diagram illustrating an example method 150 which may be carried out by the imaging system 100 of FIG. 2. As indicated by step 152, scintillator 22 of detector 20 receives ionizing radiation supplied by radiation source 102 that has passed through, around and across a body being imaged. As indicated by step 154, in response to being impinged by such ionizing radiation, scintillator 22 converts the energy of the radiation into optical photons having a first wavelength WL1.

As indicated by step 156, wavelength shifting material 26 receives photons through a photon emitting area of scintillator 22 and transmits photons from an input side of the material to an output side of the material along a path normal to the light output face. During such transmission, wavelength shifting material 26 shifts the wavelength of the photons received from scintillator 22 to a different wavelength (wavelength WL2) at which solid-state photomultiplier 24 has an enhanced photon detection efficiency. In one example implementation, wavelength shifting material 26 upwardly shifts the wavelength of the photons received from scintillator 22. In one implementation, wavelength shifting material 26 receives photons having a peak wavelength of less than 450 nm (nominally 420 nm; the blue light being emitted by scintillator 22) and isotropically re-emits the same photons with the wavelength of at least 450 nm and less than or equal to about 600 nm (nominally 500 nm within a range of green light (480 nm to 600 nm).

As indicated by step 158, solid-state photomultiplier 24 receives such photons through wavelength shifting material and senses such photons to produce electrical pulses or electrical signal. As noted above, in the particular implementation shown in FIG. 2, such electrical signals produced by detector 20 are further amplified, discriminated and counted to generate an image that is displayed and/or recorded.

FIG. 4 is a sectional view illustrating radiation detector 220, an example implementation of radiation detector 20. As shown by FIG. 4, radiation detector 220 comprises scintillator 222, solid-state photomultiplier 224 and wavelength shifting material 226. Scintillator 222 and solid-state photomultiplier 224 are substantially identical to scintillator 22 and solid-state photomultiplier 24 described above. Wavelength shifting material 226 is similar to wavelength shifting material 26 described above except that wavelength shifting material to 26 is illustrated as being sandwiched between and in direct contact with each of scintillator 222 and solid-state photomultiplier 224. As with wavelength shifting material 26, wavelength shifting material 226 shifts the wavelength of the photons received from scintillator 22 to a different wavelength at which solid-state photomultiplier 24 has an enhanced photon detection efficiency. As with wavelength shifting material 26, wavelength shifting material 226 transmits photons from an input side 230 of the material to an output side 232 of the material along and about a straight linear path. Because wavelength shifting material 226 is sandwiched between scintillator 222 and solid-state photomultiplier 224, the transmission of photons is more efficient and detector 220 may be more compact.

FIG. 4 further schematically illustrates operation of detector 220. As shown by FIG. 4, incident radiation 250 from a radiation source, such as radiation source 102 (shown in FIG. 2) impinges or is incident upon scintillator 222. The incident radiation 250 scintillator excites scintillator 222 such that scintillator 222 generates or releases a scintillator optical photon 252. The optical photon 252 moves through scintillator 222 and may bounce off internal surfaces or peripheries of scintillator 222 prior to exiting scintillator 222 into wavelength shifting material 226. Wavelength shifting material 226 receives the optical photon through its input side 230. While the optical photon is within wavelength shifting material 226, wavelength shifting material 226 absorbs the photon with wavelength WL1 and re-emits a photon of shifted wavelength WL2. Ultimately, the photon having the shifted wavelength exits wavelength shifting material 226 through output side 232 and into solid-state photomultiplier 224. As shown in FIG. 4, optical photons produced by scintillator 222 may take various paths prior to reaching solid-state photomultiplier 224. For example, as indicated by paths 256 and 258, a photon may pass directly from scintillator 222, directly across wavelength shifting material 226 and directly into solid-state photomultiplier 224. As indicated by path 260, and optical photon may exit scintillator 222, temporarily passed through wavelength shifting material 226 where its wavelength may be shifted, reflect a return back to scintillator 222 with the shifted wavelength, and ultimately passed through wavelength shifting material 226 once again prior to reaching solid-state photomultiplier 224. As indicated by path 262, a photon may bounce around or be internally reflected within wavelength shifting material 226 prior to exiting through output side 232 to solid-state photomultiplier 224. Lastly, as represented by pulses 268, solid-state photomultiplier 224 receives such photons and produces electrical pulses or signals 268 which are output for possible amplification and counting to produce an image.

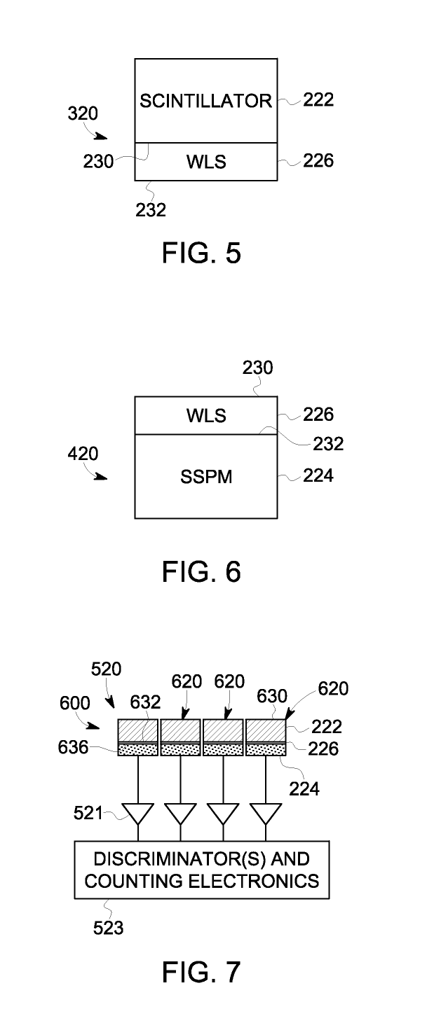

As shown by FIGS. 5 and 6, in some implementations, portions of radiation detector 220 may be separated or componentized for subsequent use or assembly with the other components of radiation detector 220. FIG. 5 schematically illustrates radiation detector component 320. Component 320 comprises scintillator 222 and wavelength shifting material 226, described above. In one implementation, wavelength shifting material 226 may comprise the wavelength shifting light guide. In another implementation, wavelength shifting material 226 may comprise a wavelength shifting compound. Wavelength shifting material 226 shifts the wavelength of the photons received from scintillator 22 to a different wavelength at which solid-state photomultiplier 24 has an enhanced photon detection efficiency. Wavelength shifting material 226 transmits photons from an input side 230 of the material to an output side 232 of the material along and about a straight linear path. Component 320 is for being combined with solid-state photomultiplier 224 to form radiation detector 220 or for forming a radiation detector 20.

FIG. 6 illustrates radiation detector component 420. Component 420 comprises scintillator 222 and wavelength shifting material 226, described above. In one implementation, wavelength shifting material 226 may comprise the wavelength shifting light guide. In another implementation, wavelength shifting material 226 may comprise a wavelength shifting compound. Wavelength shifting material 226 shifts the wavelength of the photons received from scintillator 22 to a different wavelength at which solid-state photomultiplier 24 has an enhanced photon detection efficiency. Wavelength shifting material 226 transmits photons from an input side 230 of the material to an output side 232 of the material along and about a straight linear path. Component 420 is for being combined with a scintillator 222 to form radiation detector 220 or for forming a radiation detector 20.

FIG. 7 schematically illustrates detector 520, an example of detector 20. FIG. 4 further illustrates detector 520 supplying signals to buffer amplifiers 521 which amplify the signals outputted from detector 220 prior to such signals being discriminated and counted by electronics 523. Detector 520 comprises an array 600 of detector cells or detector units 620. Each detector unit 620 comprises scintillator 222, solid state photomultiplier 224 and wavelength shifting material 226. Scintillator 222 is described above. In the example illustrated, scintillator 222 comprises a body of scintillation material surrounded by reflective surfaces but for a photon emitting area. In the example illustrated in which scintillator 222 is depicted as a six sided rectangle, scintillator 222 includes five reflective faces 630, the four sides and the top, and a lower or bottom face 632 (omitting any reflective material) serving as the photon emitting area of scintillator 222. The reflective faces may be formed by coatings of materials that are spectrally opaque to the wavelength of the scintillator light or photons produced by scintillator 222.

In one implementation, the reflective faces may be formed by white paint, such as titanium oxide. In other implementations, the reflective faces may be formed by other reflective material such as polytetrafluoroethylene (TEFLON) tape, white plastics, white epoxies, reflective metals, glues and the like. In other implementations, scintillator 222 may have other shapes with other configurations or material compositions for the reflective surfaces that define or form the photon emitting area of the scintillator 622.

Solid-state photomultiplier 224 is described above. Solid-state photomultiplier 224 comprises an input 636 through which photons produced by scintillator 222 are received and absorbed by photomultiplier 224. Solid-state photomultiplier 224 produces electrical signals corresponding to the received optical photons from scintillator 222. Wavelength shifting material 226 comprises a material, such as a wavelength shifting light guide or a wavelength shifting compound, configured to shift a wavelength of photons emitted by scintillator 222 prior to emitting the wavelength shifted photons to solid-state photomultiplier 224. Wavelength shifting material 226 shifts the wavelength of the photons received from scintillator 222 to a different wavelength at which solid-state photomultiplier 224 has an enhanced photon detection efficiency. Solid-state photomultiplier 224 converts photons to electrons at a quantum efficiency characteristic of the material or construction of photomultiplier 224. Solid-state photomultiplier 224 has a maximum quantum efficiency when receiving photons having an optimal wavelength. In one implementation, the optimal wavelength of a photon at which solid-state photomultiplier 224 converts the photon to an electron or electrical signal is a wavelength between 450 nm and 600 nm. In one implementation, the quantum efficiency of solid-state photomultiplier 224 exhibits a bell curve with the peak of the bell curve occurring at the optimal wavelength of 500 nm (green light) or thereabouts. In one implementation, solid-state photomultiplier 224 has a photon detection efficiency of between 4% and 5% when receiving photons having a peak wavelength of around 420 nm and a photon detection efficiency of about 14% when receiving photons having a peak wavelength of about 500 nm.

In one example implementation, wavelength shifting material 226 upwardly shifts the wavelength of the photons received from scintillator 222. In one implementation, wavelength shifting material 226 receives photons having a peak wavelength of less than 450 nm (nominally 420 nm; the blue light being emitted by scintillator 222) and isotropically re-emits the same photons with the wavelength of at least 450 nm and less than or equal to about 600 nm (nominally 500 nm within a range of green light (480 nm to 600 nm). The shifted photons emitted from constrictor 226 are directed or guided in a linear or straight optical path to solid-state photomultiplier 224.

Electronics 523 comprise electronics that receive the microcell electrical pulses or electrical signals from solid-state photomultiplier 224 of detector 520. In the example illustrated, electronics 523 discriminates such signals and counts such signals. In one implementation, electronics 523 includes discriminators that compare a voltage of a signal to a predefined threshold voltage to determine whether the signal being received is the result of the reception of a photon by solid-state photomultiplier 224 or is due to noise. Those signals that are determined to have a voltage greater than a threshold voltage are counted by electronics 523.

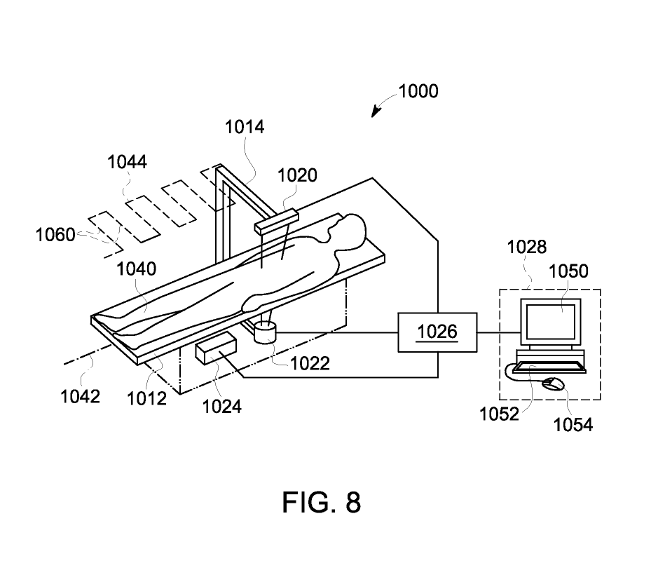

FIG. 8 illustrates imaging system 1000, an example implementation of imaging system 100. In one implementation, imaging system 1000 comprises a dual x-ray absorptiometry (DEXA or DXA) system. In other implementations, system 1000 may be utilized for other purposes and may have other configurations. Imaging system 1000 comprises patient table 1012, support 1014, detector 1020, radiation source 1022, translation drive 1024, interface device 1026 and controller 1028. Patient table 1012 comprises a structure providing them horizontal surface for supporting a subject, for example, a patient 1040, in a supine or lateral position along a longitudinal axis 1042.

Support 1014 comprises a structure configured to support detector 1020. In the example implementation, support 1014 further supports radiation source 1022. Support 1014 is operably coupled to translation drive 1024 such that support 1014, along with detector 1020 and radiation source 1022, may be incrementally moved along a scanning path 1044. In other implementations where the subject or object being imaged is smaller where a particular defined region of the subject object is to be imaged, support 1014 may alternatively stationarily support detector 1020, wherein translation drive 1024 is omitted.

Detector 1020 detects radiation, such as x-rays, that is passed through patient 1040. Detector 1020 comprises an implementation of detector 20 described above. In some implementations, detector 1020 comprises an implementation of any of detectors 220, and 520.

Radiation source 1022 directs radiation through table 1012 through patient 1042 towards detector 1020. Radiation source 1020 comprises an implementation of radiation source 102. As noted above, in implementations where imaging system 1000 comprises a dual energy x-ray imaging system, radiation source 1022 may direct at least two levels of radiation towards detector 1020.

Interface device 1028 comprises a device by which data or information produced from the signals received from detector 1020 are stored, presented or provided to a person. In the example illustrated, interface device 1028 comprises a monitor 1050 and input devices 1052 and 1054. Monitor 1050 comprise a screen by which the results from imaging system 1000 may be displayed. Input devices 1052 and 1054, illustrated as comprising a keyboard and a mouse, respectively, comprise devices by which a person may enter instructions, commands or selections as to how data should be presented on monitor 1050, as to where or how such data should be stored and as to the particular operation of imaging system 1000. In other implementations, interface device 1028 may have other configurations, including other display devices and other input devices.

Controller 1026 comprises one or more processing units configured to receive signals from detector 1020, to process such signals to produce data or information, to generate control signals displaying or storing the raw signals and/or the produced data and to generate control signals directing the operation of imaging system 1000, such as the operation of radiation source 1022 and drive 1024. For purposes of this application, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry or electronics may be used in place of or in combination with software instructions to implement the functions described. For example, controller 1026 may be embodied as part of one or more application-specific integrated circuits (ASICs). Unless otherwise specifically noted, the controller is not limited to any specific combination of hardware circuitry and software, nor to any particular source for the instructions executed by the processing unit. In the example illustrated, controller 126 (which is schematically illustrated) may be embodied as part of a single computing system which also provides monitor 1050 and inputs 1052, 1054. In other implementations, controller 126 may be implemented as a separate control unit distinct from the illustrated computing system. In some implementations, controller 126 may be implemented in several modules or separate units.

Imaging system 1000 may carry out the method 150 described above with respect to FIG. 3. In one implementation, in response to receiving input instructions through input 1052 or 1054, controller 1026 generate control signals directing radiation source 1022 to direct radiation through patient 1040 towards detector 1020. During such movement, controller 1026 further generates control signals directing drive 1024 to move radiation source 1022 and detector 1020 in a raster pattern 1058 so as to trace a series of transverse scans 1060 of patient 1040.

During such scans, energy x-ray data is collected by detector 1020. In particular, scintillator 22, 222 receives ionizing radiation and converts the energy or radiation into photons. The photons emitted by scintillator 22, 222 are passed through a wavelength shifting material 26, 226 to solid-state photomultiplier 24, 324 which produces logical signals. As noted above, while within wavelength shifting material 26, 226, the wavelengths of such photons are shifted to enhance the photon detection efficiency of detector 1020.

The electrical signals produced by detector 1020 are amplified, discriminated and counted by electronics associated with controller 1026. Such counted signals are then utilized to produce an image of patient 1040. The image is stored and/or displayed on monitor 1050. As noted above, in one implementation, multiple levels of x-ray energy may be provided by source 1022 to perform dual energy x-ray absorptiometry for acquiring such data as bone density. In other implementations, imaging system 1000 may have other configurations and may perform other methods.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An apparatus for comprising:
one of a scintillator and a solid-state photomultiplier; and
a wavelength shifting material optically coupled to said one of the scintillator and the solid-state photomultiplier, wherein the wavelength shifting material transmits photons from an input side of the material to an output side of the material along a straight linear path.

2. The apparatus of claim 1, wherein the wavelength shifting material comprises a wavelength shifting light guide.

3. The apparatus of claim 1, wherein the wavelength shifting material comprises an optical coupling compound including a wavelength shifting dopant.

4. The apparatus of claim 1, wherein said one of a scintillator and a solid-state photomultiplier comprises the scintillator.

5. The apparatus of claim 4, wherein the wavelength shifting material upwardly shifts the wavelength of photons received from the scintillator.

6. The apparatus of claim 5, wherein the wavelength shifting material upwardly shifts the wavelength of photons received from the scintillator to a wavelength of at least 450 nm and less than or equal to 600 nm.

7. The apparatus of claim 4, wherein the scintillator emits photons having wavelength of less than 450 nm.

8. The apparatus of claim 4, wherein the scintillator is formed from a material selected from a group of materials consisting of: Lu1.8Y0.2SiO5:Ce (LYSO); Lu2SiO5:Ce (LSO); NaLTl; Gd2SiO5:Ce (GSO); LaBr3:Ce; YAP; LuAlO2 (LuAP); and BaF2.

9. The apparatus of claim 1, wherein said one of a scintillator and a solid-state photomultiplier comprises the solid-state photomultiplier.

10. The apparatus of claim 9, wherein the solid-state photomultiplier has a maximum quantum efficiency when receiving photons having an optimum wavelength, the optimum wavelength comprising a wavelength between 450 nm and 600 nm.

11. The apparatus of claim 1 comprising both the scintillator and the solid-state photomultiplier, wherein the wavelength shifting material is operably coupled between the scintillator and the solid-state photomultiplier.

12. The apparatus of claim number 11, wherein the wavelength shifting material is in contact with the scintillator and the solid-state photomultiplier.

13. The apparatus of claim 11 further comprising an x-ray source to direct x-rays to the scintillator.

14. The apparatus of claim 13 further comprising amplification electronics, discriminating electronics and counting electronics connected to the solid-state photomultiplier.

15. A medical imaging system comprising:
a radiation source;
a scintillator to receive rays of radiation emitted by the radiation source and passing through an imaged body;
a wavelength shifting material optically coupled to the scintillator to shift a wavelength of an optical photon received from the scintillator, wherein the wavelength shifting material transmits photons from an input side of the material to an output side of the material along a straight linear path; and
a solid-state photomultiplier optically coupled to the wavelength shifting material to receive the optical photon having the wavelength shifted by the wavelength shifting material.

16. The medical imaging system of claim 15, wherein the wavelength shifting material upwardly shifts the wavelength of photons received from the scintillator to a wavelength of at least 450 nm and less than or equal to 600 nm.

17. The medical imaging system of claim 16, wherein the scintillator emits photons having wavelength of less than 450 nm.

18. The medical imaging system of claim 15, wherein the solid-state photomultiplier has a maximum quantum efficiency when receiving photons having an optimum wavelength, the optimum wavelength comprising a wavelength between 450 nm and 600 nm.

19. The medical imaging system of claim 15, wherein the wavelength shifting material comprises a wavelength shifting light guide.

20. The medical imaging system of claim 15, wherein the wavelength shifting material comprises an optical coupling compound including a wavelength shifting dopant.

21. A method comprising:
receiving ionizing radiation that has passed through a body being imaged;
converting absorbed energy into photons having a first wavelength;
receiving the photons on input side of a wavelength shifting material and transmitting the photons in a linear straight path to an output side of the wavelength shifting material where the photons are emitted with a second wavelength shifted from the first wavelength; and
receiving and sensing the photons with a second wavelength to produce an electrical signal.
